(19) United States
(12) Patent Application Publication
(10) Pub. No.: US 2014/0307434 A1
(43) Pub. Date: Oct. 16, 2014

(54) LIGHT SOURCE MODULE

(71) Applicant: WINTEK CORPORATION, Taichung City (TW)

(72) Inventors: Zhi-Ting Ye, Miaoli County (TW); Ming-Chuan Lin, Taichung City (TW); Chia-Hung Pan, Taichung City (TW); Wen-Chieh Wu, New Taipei City (TW)

(73) Assignee: WINTEK CORPORATION, Taichung City (TW)

(21) Appl. No.: 14/249,358

(22) Filed: Apr. 10, 2014

(30) Foreign Application Priority Data
Apr. 10, 2013 (TW) 102206529

(51) Int. Cl. F21K 99/00

(52) U.S. Cl. CPC F21K 9/50
USPC 362/235

(57) ABSTRACT

A light source module includes a base, a plurality of light emitting components and a reflecting member. The light emitting components is disposed on the base, and the adjacent light emitting components form a gap therebetween. The reflecting member is disposed on the base and surrounded by the light emitting components. The reflecting member has a reflecting surface facing the light emitting components so as to avoid the light from being blocked by the opposite light emitting component and to redirect the light project via the gap formed between the adjacent light emitting components.

### BACKGROUND OF THE INVENTION

1. Field of the Invention

The present invention relates to a light source module, and more particularly, to a light source module with a reflecting member for enhancing illumination efficiency.

2. Description of the Prior Art

Recently, since light emitting diode (LED) has advantages of lower power consumption, long life and no warm-up period, it has become a trend in the light source module instead of a conventional bulb. TW patent No. 445354 discloses a conventional light source module with light emitting diodes, wherein a plurality of light emitting diodes are annularly arranged on the base in a spaced manner, and each of the light emitting diodes is away from the facing light emitting diode by a distance, so that an emission angle of a light emitted from each of the light emitting diodes covers the facing light emitting diode. Accordingly, it can enhance illumination efficiency of the light emitting diode. However, in a lamp designed by the disclosure of TW patent No. 445354, the light emitted from the light emitting diodes is blocked by the facing light emitting diode, and thus it results in shadows in the back of the facing light emitting diode. As a result, the aforesaid design not only affects light emitting quality of the light source module but also results in disadvantages in the market due to the poor illumination efficiency resulting from the shadows in the back of the light emitting diode.

### SUMMARY OF THE INVENTION

Thus, the present invention provides a light source module capable of reducing shadows in the back of light components for solving above drawbacks.

According to an embodiment of the present invention, a light source module includes a base, a plurality of light emitting components and a reflecting member. The base has a bottom surface. The light emitting components are disposed on the base. The light emitting components adjacent to each other form a gap therebetween, and each of the light emitting components emits a light . The reflecting member is disposed on the base and surrounded by the light emitting components, and the reflecting member has a reflecting surface facing the light emitting components. A first angle is included between a normal of the bottom surface and the reflecting surface, such that a first portion of the light is reflected by the reflecting surface and projects via the gap between the adjacent light emitting components in a direction toward or away from the base, and a second portion of the light directly projects via the gap between the adjacent light emitting components.

According to another embodiment of the present invention, a radius of a cross-section of the reflecting member decreases gradually in the direction away from the base, such that the first portion of the light is reflected by the reflecting surface and projects in the direction away from the base.

According to another embodiment of the present invention, a radius of a cross-section of the reflecting member increases gradually in the direction away from the base, such that the first portion of the light is reflected by the reflecting surface and projects in the direction toward the base.

According to an embodiment of the present invention, a light source module includes a base, a plurality of light emitting components and a reflecting member. The base has a bottom surface. The plurality of light emitting components are disposed on the base. The light emitting components adjacent to each other form a gap therebetween, and each of the light emitting components emits a light. The reflecting member is disposed on the base and surrounded by the light emitting components, and the reflecting member has a reflecting surface facing the light emitting components. A second angle is included between the normal of the bottom surface and each of the light emitting components, such that a first portion of the light is reflected by the reflecting surface and projects via the gap between the adjacent light emitting components in a direction toward or away from the base, and a second portion of the light directly projects via the gap between the adjacent light emitting components.

In summary, the present invention utilizes the reflecting member to reflect and block the light emitted from the light emitting component located on one side of the reflecting member from reaching the light emitting component located on the opposite side of the reflecting member. Thus, light will not reach at the opposite light emitting component, and the shadow in the back of the light emitting component located on the opposite side of the reflecting member can be avoided, so as to enhance the illuminating quality of the light source module. At the same time, the reflecting member reflects the light to make the light project via the gap between the adjacent light emitting components. Accordingly, the lights emitted from both sides of the light emitting component of the present invention can both be used for illumination, so as to enhance the illumination efficiency of the light source module. In addition, by the reflecting member having a cone structure, the light reflected by the reflecting member of the present invention further projects in the direction toward or away from the base, so as to reinforce illumination of the light source module in positions toward or away from the base and increase the illumination range of the light source module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a light source module according to a first embodiment of the present invention.

FIG. 2 is a sectional diagram of a light emitting component according to the first embodiment of the present invention.

FIG. 3 is a top view of the light source module according to the first embodiment of the present invention.

FIG. 4 is a sectional diagram of the light source module along the line X-X in FIG. 3 according to the first embodiment of the present invention.

FIG. 5 is a sectional diagram of a light source module according to a second embodiment of the present invention.

FIG. 6 is a sectional diagram of a light emitting component according to the second embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. In this regard, directional terminology, such as “top,” “bottom,” etc., is used with reference to the orientation of the Figure (s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

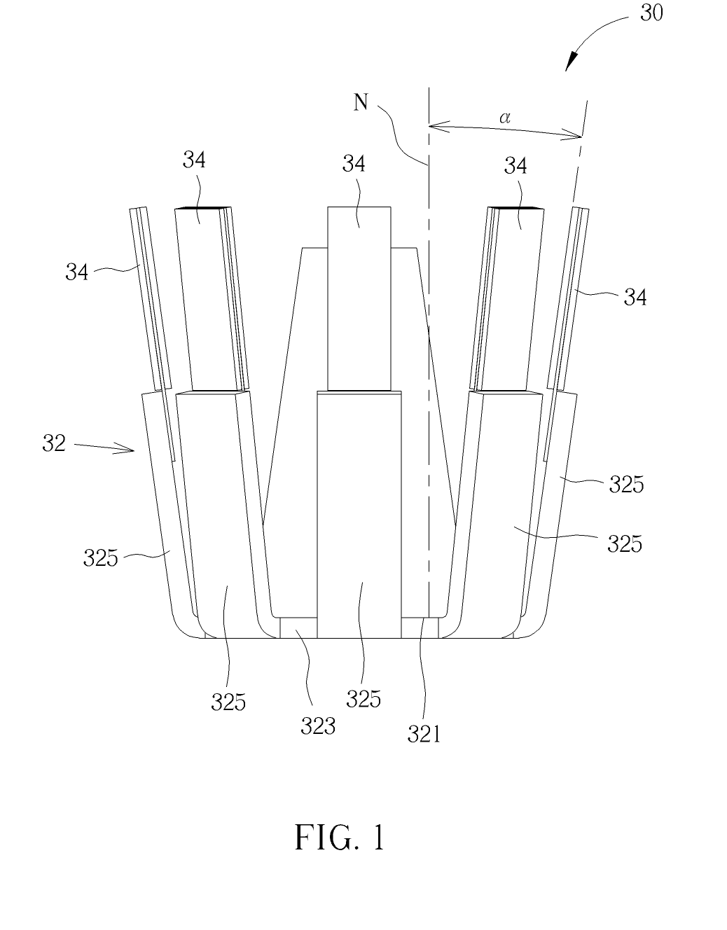

Please refer to FIG. 1. FIG. 1 is a schematic diagram of a light source module 30 according to a first embodiment of the present invention. As shown in FIG. 1, the light source module 30 includes a base 32 and a plurality of light emitting components 34 annularly disposed on the base 32 in a spaced manner. The base 32 can be coupled to a lamp head module (not shown in figures) and has a bottom surface 321. The light emitting components 34 are electrically connected to the base 32, such that the light emitting components 34 can receive power through the base 32 to emit light. Furthermore, the base 32 includes a body 323 and a plurality of holding members 325. The bottom surface 321 is formed on the body 323. The holding members 325 are connected to a periphery of the body 323 and for holding the light emitting components 34.

Furthermore, the light emitting component 34 can be disposed to have a second angle a included with a normal N of the bottom surface 321 of the body 323. In this embodiment, the holding members 325 and the normal N of the bottom surface 321 of the base 32 form the second angle a therebetween. Accordingly, when the light emitting components 34 are held on the holding members 325, the light emitting components 34 and the normal N of the bottom surface 321 of the body 323 can form the second angle a therebetween, so as to adjust the light emitting angle of the light emitting component 34, thus the application flexibility of the light source module 30 can be enhanced. In this embodiment, the second angle a is between 2 degrees and 15 degrees. Practically, the second angle a can be preferably, but not limited to, 8 degrees. For example, the second angle a can be 6 degrees or 10 degrees as well. As for which one of the aforesaid designs is adopted, it depends on practical demands. In addition, the holding members 325 are further used for transmitting heat generated by the light emitting components 34 as illuminating to the body 323, such that the body 323 dissipates the heat generated by the light emitting components 34 as illuminating. Practically, the body 323 and the holding members 325 are integrally formed, and the body 323 can be, but not limited to, a Metal Core Printed Circuit Board (MCPCB). For example, the body 323 can be an aluminum heat dissipating substrate as well. As for which one of the aforesaid designs is adopted, it depends on practical demands.

The light emitting components 34 can be semiconductor light emitting components having semiconductor chips. In order to enhance illumination efficiency of the semiconductor chips in the light emitting components 34, the light emitting components 34 can be dual sided light emitting components which are embodied as follows.

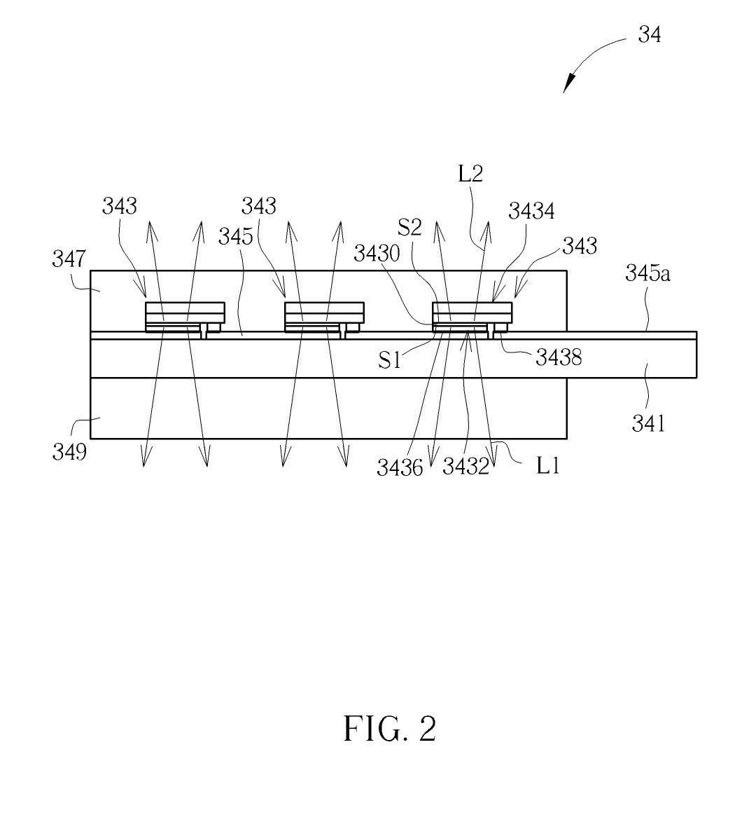

Please refer to FIG. 2. FIG. 2 is a sectional diagram of the light emitting component 34 according to the first embodiment of the present invention. As shown in FIG. 2, the light emitting component 34 includes a light-permeable substrate 341, at least one light emitting chip 343, an electrode circuit 345. The light emitting chip 343 and the electrode circuit 345 are both disposed on the light-permeable substrate 341. In this embodiment, the light emitting chip 343 is a semiconductor light emitting chip, such as a light emitting diode and so on, and the light emitting component 34 can include three light emitting chips 343 respectively coupled to the electrode circuit 345, such that the three light emitting chips 343 can receive power through the electrode circuit 345 to emit light. An amount of the light emitting chip 343 of the present invention is not limited to those mentioned in this embodiment, and it depends on practical demands. In addition, in this embodiment, the light-permeable substrate 341 can be made of Silicon carbide (SiC) which is transparent and suitable for being used in semiconductor process, such that the light emitted from the light emitting chip 343 can pass through the light-permeable substrate 341. The material of the light-permeable substrate 341 of the present invention is not limited to those mentioned in this embodiment. For example, the light-permeable substrate 341 can be made of aluminum oxide or glass as well. As for which one of the aforesaid designs is adopted, it depends on practical demands.

In summary, since light transmission property of the light-permeable substrate 341 allows the light emitted from the light emitting chip 343 to pass through, the light can travel in opposite directions away from both sides of the light-permeable substrate 341. Accordingly, the light emitting component 34 of the present invention is capable of emitting light from both sides thereof for enhancing the illumination efficiency of the light emitting component 34. It should be noticed that the electrode circuit 345 can be made of transparent metal oxide (e.g. indium oxide tin), such that the electrode circuit 345 is transparent as well for further enhancing the illumination efficiency of the light emitting component 34. The material of the electrode circuit 345 is not limited to those mentioned in this embodiment. For example, the electrode circuit 345 can be made of other transparent conductive material, such as graphene, as well. As for which one of the aforesaid designs is adopted, it depends on practical demands.

As shown in FIG. 2, the light emitting chip 343 has a light emitting layer 3430, a first light emitting surface 3432, and a second light emitting surface 3434. The first light emitting surface 3432 and the second light emitting surface 3434 are corresponding to a first side S1 and a second side S2 of the light emitting layer 3430 respectively. The light emitting chip 343 further includes a first electrode 3436 and a second electrode 3438. The light emitting chip 343 is bound through the first light emitting surface 3432 onto the light-permeable substrate 341 in a flip-chip way, so that the first electrode 3436 and the second electrode 3438 are electrically connected to the electrode circuit 345. In this embodiment, the three light emitting chips 343 are disposed on the same side of the light-permeable substrate 341. In addition, the light emitting component 34 further includes a first cover layer 347 including color conversion material (such as phosphor powder and so on) and covers the second light emitting surface 3434 of the light emitting chip 343, so as to package the light emitting chip 343 on the light-permeable substrate 341. Furthermore, the light emitting components 34 further includes a second cover layer 349 including color conversion material and covers another side of the light-permeable substrate 341 where none of the light emitting chip 343 is disposed. In summary, when the light emitting component 34 is activated, a first light beam L1 emitted from the first side S1 of the light emitting layer 3430 projects out of the light emitting chip 343 via the first light emitting surface 3432 and passes through the light-permeable substrate 341 and the second cover layer 349, and a second light beam L2 emitted from the second side S2 of the light emitting layer 3430 projects out of the light emitting chip 343 via the second light emitting surface 3434 and passes through the first cover layer 347.

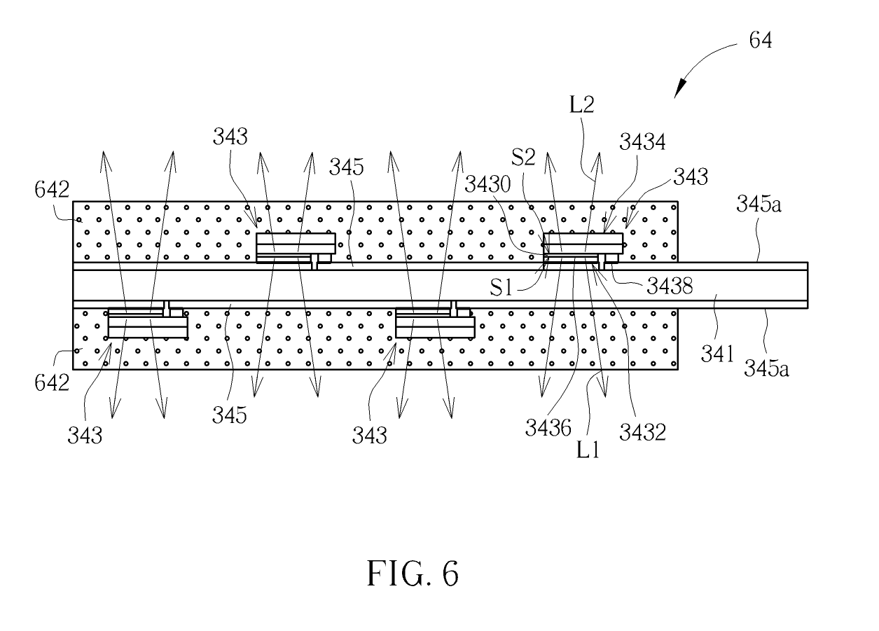

It should be noticed that structures of the light emitting component 34 of the present invention is not limited to those mentioned in this embodiment, and another embodiment is illustrated as follows. Please refer to FIG. 6. FIG. 6 is a sectional diagram of a light emitting component 64 according to a second embodiment of the present invention. Components with denoted in this embodiment identical to those in the aforesaid embodiment have identical structures and functions, and further description is omitted herein for simplicity. As shown in FIG. 6 and FIG. 2, the main difference between the light emitting component 64 and the light emitting component 34 is that the light emitting chips 343 in the light emitting component 64 are disposed on opposite sides of the light-permeable substrate 341 in a staggered way. The light emitting component 64 further includes two color conversion layers 642 respectively disposed on the opposite sides of the light-permeable substrate 341 for at least covering the light emitting chips 343. Accordingly, the two color conversion layers 642 are capable of enhancing uniformity of color temperature and illumination of the light emitting component 64. In another embodiment, the plurality of light emitting chips 343 of the light emitting component 64 can be disposed on the opposite sides of the light-permeable substrate 341 and each two of the light emitting component 64 are aligned each other, but the invention is not limited thereto.

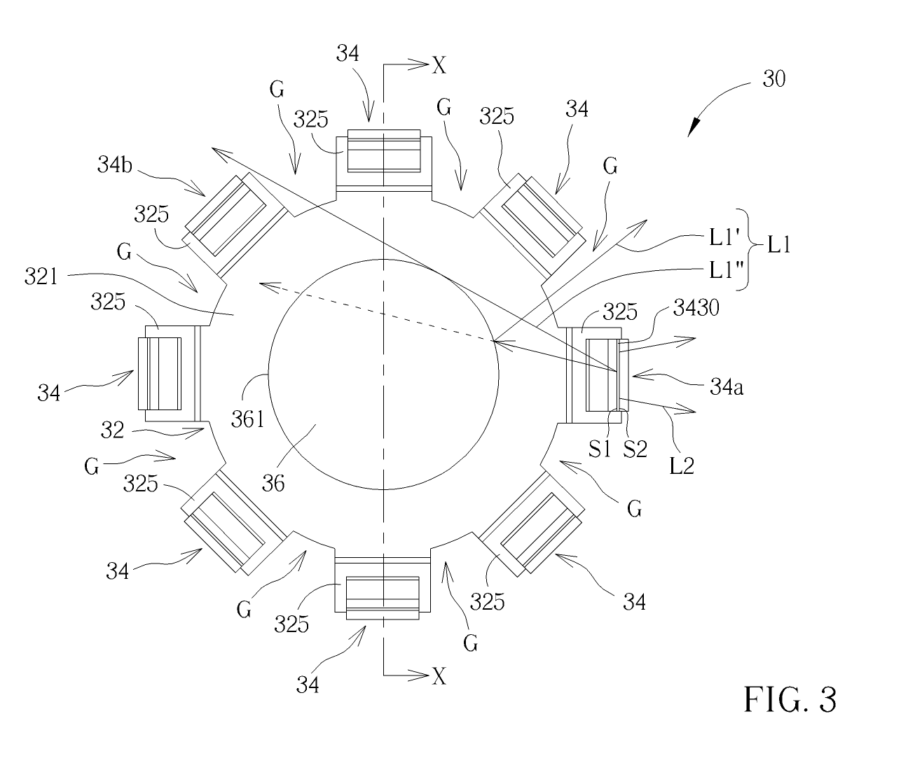

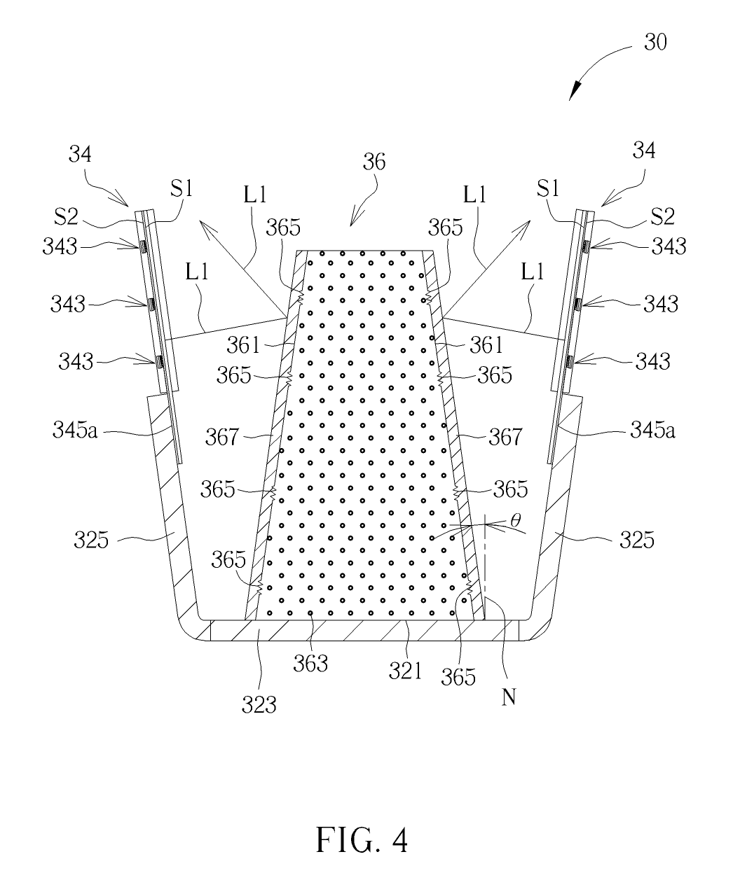

Please refer to FIG. 2 to FIG. 4. FIG. 3 is a top view of the light source module 30 according to the first embodiment of the present invention. FIG. 4 is a sectional diagram of the light source module 30 along the line X-X in FIG. 3 according to the first embodiment of the present invention. As shown in FIG. 2 to FIG. 4, the first cover layer 347 exposes a portion of the electrode circuit 345 as terminals 345a for being coupled to the base 32. For example, the terminals 345a are coupled to the corresponding terminals (not shown in figures) disposed on the holding member 325 which is connected to the periphery of the base 32. Accordingly, the light emitting chips 343 of the light emitting component 34 can be electrically connected to the base 32. In addition, the plurality of light emitting components 34 of the present invention are annularly disposed on the base 32, in which the adjacent light emitting components 34 form a gap G therebetween. The light source module 30 further includes a reflecting member 36 disposed on the body 323 of the base 32 and surrounded by the plurality of light emitting components 34, e.g. the reflecting member 36 can be disposed in a center of the body 323. Furthermore, the reflecting member 36 has a reflecting surface 361 facing the light emitting components 34. The reflecting surface 361 is used for reflecting the light emitted from the light emitting components 34. It should be noticed that first light emitting surface 3432 faces the reflecting member 36 and the second light emitting surface 3434 opposite to the reflecting member 36.

As shown in FIG. 3 and FIG. 4, when the light emitting component 34a located on a side of the reflecting member 36 illuminates, the first light beam L1 emitted from the first side S1 of the light emitting layer 3430 of the light emitting component 34a will project toward the light emitting component 34b located on the opposite side of the reflecting member 36. In the case without the reflecting member 36, the travel path of the first light beam L1 is shown as the dashed line in FIG. 3. In order to avoid the first light beam L1 from being blocked by the light emitting component 34b thereby causing shadows in the back of the light emitting component 34b, the present invention provides the reflecting member 36 with the reflecting surface 361 facing each of the light emitting components 34, such that a first portion L1′ of the first light beam L1 is reflected by the reflecting surface 361 and projects via the gap G between the adjacent light emitting components 34, and a second portion L1″ of the first light beam L1 directly projects via the gap G between the adjacent light emitting components 34. Similarly, since the reflecting member 36 prevents the first light beam L1 emitted from the light emitting component 34 from being blocked by the light emitting component 34 on the opposite side and thus prevents the shadow in the back of the light emitting component 34 on the opposite side, the reflecting member 36 of the present invention is used for reducing the shadow in the position against the light relative to the light emitting component 34, so as to enhance illuminating quality of the light source module 30.

In addition, the first portion L1′ of the first light beam L1 projecting toward the light emitting component 34b is reflected by the reflecting surface 361 of the reflecting member 36, such that the first portion L1′ of the first light beam L1 projects via the gap G of the adjacent light emitting components 34 located on the side of the reflecting member 36. In other words, an object located on the side of the reflecting member 36 can be illuminated by not only the second light beam L2 emitted from the second side S2 of the light emitting layer 3430 of the light emitting component 34a but also the first portion L1′ of the first light beam L1, so as to enhance intensity of light applied on the object located on the side of the reflecting member 36, i.e. the light source module 30 of the present invention can have an improved illumination efficiency.

In this embodiment, the reflecting member 36 can be made of opaque material including a plurality of diffusively reflecting particles 363 therein for diffusing and reflecting the light emitted from the light emitting components 34, so as to enhance illuminating uniformity of the light source module 30. The term of opaque means not clear or even unable to be seen through so as a person cannot view clearly what is behind the reflecting member 36. Practically, the diffusively reflecting particles 363 can be made of silicon dioxide, but the present invention is not limited thereto. For example, the diffusively reflecting particles 363 can be made of titanium dioxide or a combination of silicon dioxide and titanium dioxide. As for which one of the aforesaid designs is adopted, it depends on practical demands. In addition, the reflecting surface 361 of the reflecting member 36 can include a plurality of micro structures 365. In another embodiment, the reflecting surface 361 is made of a reflective coating layer 367. The micro structures 365 and the reflective coating layer 367 can be used solely or in a combination for reflecting the light emitted from the light emitting component 34, so as to further adjust reflecting effect of the reflecting member 36 flexibly. Practically, the reflective coating layer 367 is made of metal material or ink including base material and diffusively reflecting particles. The reflective coating layer 367 made of metal material provides specular reflecting effect, and the reflective coating layer 367 made of ink including diffusively reflecting particles provides diffusively reflecting effect. In this embodiment, the reflective coating layer 367 can include a material selected from the group consisting of titanium dioxide, silicon dioxide and a combination thereof. It should be noticed that the reflecting member 36 can be made of transparent plastic material coated with the reflective coating layer 367 on its surface to form the reflecting surface 361. In such a manner, the reflecting member 36 can save dying cost during manufacture, so as to enhance fabrication tolerance of the reflecting member 36 and thus to facilitate mass production.

In this embodiment, as shown in FIG. 4, a first angle θ is included between the reflecting surface 361 of the reflecting member 36 and the normal N of the bottom surface 321 of the body 323, and a radius of a cross-section of the reflecting member 36 decreases gradually in a direction away from the base 32. For example, the reflecting member 36 is a truncated circular cone structure. In other words, a normal of the reflecting surface 361 of the reflecting member 36 is rotated counterclockwise from a horizon by the first angle θ, i.e. the normal of the reflecting surface 361 of the reflecting member 36 is slanted upwards. When the first light beam L1 emitted from the light emitting component 34 reaches the reflecting surface 361 of the reflecting member 36, since the normal of the reflecting surface 361 is slanted upwards, the first light beam L1 is reflected by the reflecting surface 361 and projects in a direction away from the base 32. Accordingly, the intensity of light of the light source module 30 in the direction away from the base 32 is enhanced. In this embodiment, the first angle θ is between 2 degrees and 15 degrees. It should be noticed that the first angle θ included between the reflecting surface 361 of the reflecting member 36 and the normal N of the bottom surface 321 can not be identical to the second angle α included between each of the light emitting component 34 and the normal N of the bottom surface 321. In other words, an angle difference (i.e. a difference between the first angle θ and the second angle α) is included between the reflecting surface 361 of the reflecting member 36 and the light emitting component 34, that is, the reflecting surface 361 of the reflecting member 36 and each of the light emitting components 34 are non parallel oriented.

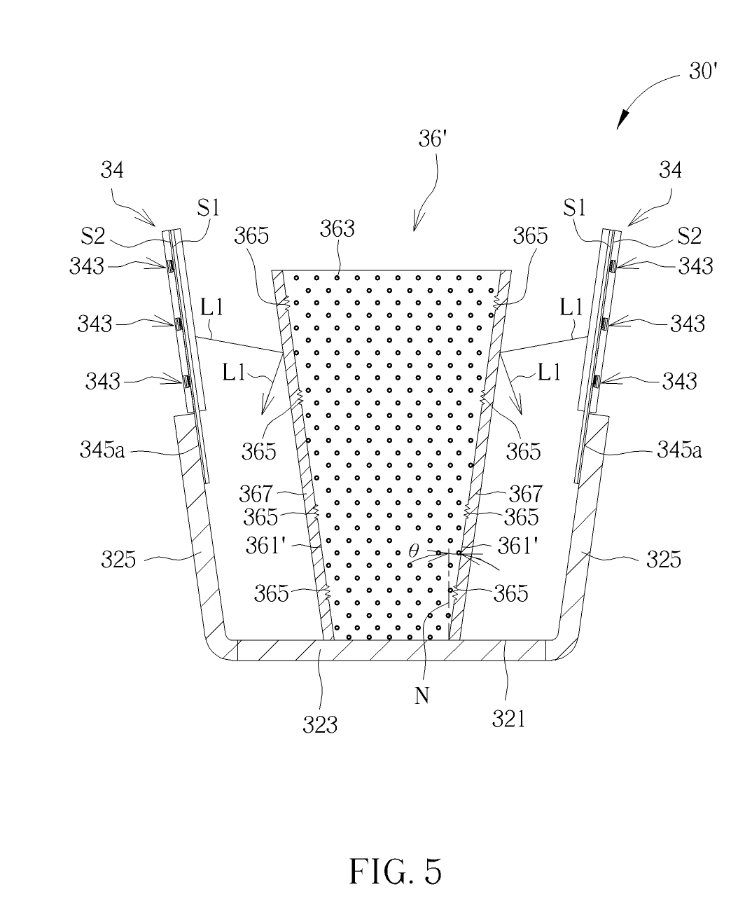

Please refer to FIG. 5. FIG. 5 is a sectional diagram of a light source module 30′ according to a second embodiment of the present invention. As shown in FIG. 5, the first angle θ is included between the reflecting surface 361′ of the reflecting member 36′ and the normal N of the bottom surface 321 of the body 323. The main difference between the light source module 30′ and the aforesaid light source module 30 is that a radius of a cross-section of a reflecting member 36′ of the light source module 30′ increases gradually in a direction away from the base 32, e.g. the reflecting member 36′ is a reverse circular truncated cone structure. In other words, a normal of a reflecting surface 361′ of the reflecting member 36′ is rotated clockwise from the horizon by the first angle θ, i.e. the normal of the reflecting surface 361′ of the reflecting member 36′ is slanted downwards. When the first light beam L1 emitted from the light emitting component 34 reaches the reflecting surface 361′ of the reflecting member 36′ , since the normal of the reflecting surface 361′ is slanted downwards, the first light beam L1 is reflected by the reflecting surface 361′ and projects in a direction toward the base 32. Accordingly, the intensity of light of the light source module 30′ in the direction toward the base 32 can be enhanced. Components with denoted in this embodiment identical to those in the aforesaid embodiment have identical structures and functions, and further description is omitted herein for simplicity.

Compared to the prior art, the present invention utilizes the reflecting member surrounded by the light emitting components to reflect light emitted from the light emitting components for preventing from the shadows in the back of the light emitting components due to the light being blocked by the light emitting components, so as to enhance the illuminating quality of the light source module. At the same time, the reflecting member reflects the light to make the light project via the gap between the adjacent light emitting components. Accordingly, the lights emitted from both sides of the light emitting component of the present invention can both be used for illumination, so as to enhance the illumination efficiency of the light source module. In addition, by slanted design of the reflecting surface of the reflecting member, the light reflected by the reflecting member of the present invention further projects the light in the direction toward or away from the base, and increase the illumination range of the light source module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light source module, comprising:
a base having a bottom surface;
a plurality of light emitting components disposed on the base, the light emitting components adjacent to each other forming a gap therebetween, each of the light emitting components emitting a light; and
a reflecting member disposed on the base and surrounded by the light emitting components, the reflecting member having a reflecting surface facing the light emitting components;
wherein a first angle is included between a normal of the bottom surface and the reflecting surface, such that a first portion of the light is reflected by the reflecting surface and projects via the gap between the adjacent light emitting components in a direction toward or away from the base, and a second portion of the light directly projects via the gap between the adjacent light emitting components.

2. The light source module of claim 1, wherein a radius of a cross-section of the reflecting member decreases gradually in the direction away from the base, such that the first portion of the light is reflected by the reflecting surface and projects in the direction away from the base.

3. The light source module of claim 1, wherein a radius of a cross-section of the reflecting member increases gradually in the direction away from the base, such that the first portion of the light is reflected by the reflecting surface and projects in the direction toward the base.

4. The light source module of claim 1, wherein the reflecting member has a plurality of diffusively reflecting particles therein for diffusing and reflecting the light emitted from each of the light emitting components.

5. The light source module of claim 1, wherein the reflecting surface comprises a plurality of micro structures for reflecting the light emitted from each of the light emitting components.

6. The light source module of claim 1, wherein the reflecting surface is made of a reflective coating layer for reflecting at least one portion of the light emitted from the light emitting components.

7. The light source module of claim 6, wherein the reflective coating layer is made of metal material.

8. The light source module of claim 6, wherein the reflective coating layer comprises a material selected from the group consisting of titanium dioxide, silicon dioxide and a combination thereof.

9. The light source module of claim 1, wherein the first angle is between 2 degrees and 15 degrees.

10. The light source module of claim 1, wherein a second angle is included between the normal of the bottom surface and each of the light emitting components.

11. The light source module of claim 10, wherein the second angle is between 2 degrees and 15 degrees.

12. The light source module of claim 10, wherein the first angle is not equal to the second angle.

13. The light source module of claim 1, wherein the base comprises:
a body wherein the bottom surface is formed on the body and the reflecting member is disposed in a center of the body; and
a plurality of holding members connected to a periphery of the body, the plurality of holding members being for holding the plurality of light emitting components.

14. The light source module of claim 1, wherein each of the light emitting components comprises:
a light-permeable substrate;
an electrode circuit disposed on the light-permeable substrate; and
at least one light emitting chip disposed on the light-permeable substrate and coupled to the electrode circuit, the at least one light emitting chip comprising a first light emitting surface and a second light emitting surface, the at least one light emitting chip providing a first light beam and a second light beam, the first light beam emitting out from the first light emitting surface and passing through the light-permeable substrate, the second light beam emitting out from the second light emitting surface.

15. The light source module of claim 14, wherein each of the light emitting components comprises a plurality of light emitting chips, and the plurality of light emitting chips are disposed on the same side of the light-permeable substrate.

16. The light source module of claim 15, wherein each of the light emitting components further comprises:
a first cover layer covering the second light emitting surface of the plurality of light emitting chips, the first cover layer being made of color conversion material.

17. The light source module of claim 16, wherein each of the light emitting components further comprises:
a second cover layer covering another side of the light-permeable substrate where none of the light emitting chips is disposed, the second cover layer being made of color conversion material.

18. The light source module of claim 14, wherein each of the light emitting components comprises a plurality of light emitting chips, and the plurality of light emitting chips are disposed on opposite sides of the light-permeable substrate, and each of the light emitting components further comprises two color conversion layers respectively disposed on the opposite sides of the light-permeable substrate, so as to at least cover the light emitting chips.

19. The light source module of claim 1, wherein the reflecting member is made of opaque material.

20. A light source module, comprising:
a base having a bottom surface;
a plurality of light emitting components disposed on the base, the two adjacent light emitting components forming a gap therebetween, each of the light emitting components emitting a light; and
a reflecting member disposed on the base and surrounded by the light emitting components, the reflecting member having a reflecting surface facing the light emitting components;
wherein a second angle is included between the normal of the bottom surface and each of the light emitting components, such that a first portion of the light is reflected by the reflecting surface and projects via the gap between the two adjacent light emitting components in a direction toward or away from the base, and a second portion of the light directly projects via the gap between the two adjacent light emitting components.
